(19) United States
(12) Patent Application Publication
(10) Pub. No.: US 2015/0303528 A1
(43) Pub. Date: Oct. 22, 2015

(54) SECONDARY BATTERY WITH AN OVERCHARGE PROTECTION DEVICE

(71) Applicant: ENERGY CONTROL LIMITED, Tortola (VG)

(72) Inventor: Donald P.H WU, HSINCHU COUNTY (TW)

(73) Assignee: Energy Control Limited

(21) Appl. No.: 14/584,577

(22) Filed: Dec. 29, 2014

(30) Foreign Application Priority Data
Apr. 21, 2014 (TW) 103114358

(51) Int. Cl. H01M 10/42

(52) U.S. Cl. CPC H01M 10/4257; H01M 2010/4271

(57) ABSTRACT

A secondary battery with an overcharge protection device includes a battery case with a chamber for holding a plurality of secondary battery cells; a heat dissipation plate fixed to the battery case; and an overcharge discharge device disposed in the battery case and including a plurality of overcharge discharge modules electrically connected to the secondary battery cells. Each overcharge discharge module includes a balance resistor fixed to the heat dissipation plate. The battery case and the heat dissipation plate are made of metal, the balance resistors are cement resistors, a plurality of first connectors are electrically connected to the overcharge discharge modules, and a plurality of second connectors are electrically connected to the cement resistors and removably fixed to a corresponding one of the first connectors.

### BACKGROUND OF THE INVENTION

1. Field of the Invention

The present invention relates to a secondary battery, and more particularly to a secondary battery with an overcharge protection device.

2. Description of the Prior Art

The existing secondary battery is usually provided with a BMS (battery management system) which is used to monitor and control the charging process of each battery cells, preventing overcharge and battery damage. However, BMS is quite expensive and unreliable in quality. Therefore, BMS is replaced with an overcharge protection circuit.

With the overcharge protection circuit, the extra power is shifted to and consumed by the balance resistor, so as to prevent the voltage of the secondary battery from continuously climbing and causing damage to the battery. However, the balance resistor is a low-power resistor, which will produce too much heat energy. Besides, the battery itself will also produce heat energy. When too many secondary battery cells are charged synchronously, and the power is offloaded, the heat produced by the secondary battery will be large enough to adversely affect the charging effect.

Therefore, heat dissipation system is designed to solve this problem, and the most commonly seen heat dissipation system includes heat dissipation path, heat dissipation structure, and a fan. However, the existing heat dissipation systems are mostly independent structures, which make the secondary battery complicated, and the heat dissipation effect is limited.

The present invention has arisen to mitigate and/or obviate the afore-described disadvantages.

### SUMMARY OF THE INVENTION

The primary objective of the present invention is to provide a secondary battery with an overcharge protection device. With the metal made battery case, the heat dissipation plate and the high-power cement resistors mounted on the heat dissipation plate, the second battery of the present invention, without complicated structure, will provide a good heat dissipation performance and charging effect during charging process, substantially reducing the possibility of high temperature explosion.

To achieve the above objective, a secondary battery with an overcharge protection device in accordance with the present invention comprises: a battery case with a chamber for holding a plurality of secondary battery cells; a heat dissipation plate fixed to the battery case; and an overcharge discharge device disposed in the battery case and including a plurality of overcharge discharge modules electrically connected to the secondary battery cells, the number of the overcharge discharge modules being equal to that of the secondary battery cells, and each of the overcharge discharge modules including a balance resistor which is fixed to the heat dissipation plate and used to consume electric power.

The secondary battery with an overcharge protection device is characterized in that: the battery case and the heat dissipation plate are made of metal, the balance resistors are cement resistors, a plurality of first connectors are electrically connected to the overcharge discharge modules, and a plurality of second connectors are electrically connected to the cement resistors and removably fixed to a corresponding one of the first connectors.

Preferably, the battery case further includes an outer surface, and two spaced apart first connecting portions protruded from the outer surface, the heat dissipation plate includes a heat dissipation portion spaced apart from the outer surface of the battery case, and two second connecting portions formed on the heat dissipation portion and fixed to the first connecting portions, so that the heat dissipation plate and the battery case define a heat dissipation space for passage of liquid.

Preferably, the overcharge discharge device further comprises a circuit board which is disposed at an entrance of the chamber of the battery case and provided for electrical connection of the overcharge discharge modules and the secondary battery cells.

### BRIEF DESCRIPTION OF THE DRAWINGS

FIG. 1 is an exploded view of a secondary battery with an overcharge protection device in accordance with the present invention;

FIG. 2 is an assembly view of the secondary battery with the overcharge protection device in accordance with the present invention;

FIG. 3 is a top view of the secondary battery with the overcharge protection device in accordance with the present invention; and

FIG. 4 is a cross sectional view of the secondary battery with the overcharge protection device in accordance with the present invention.

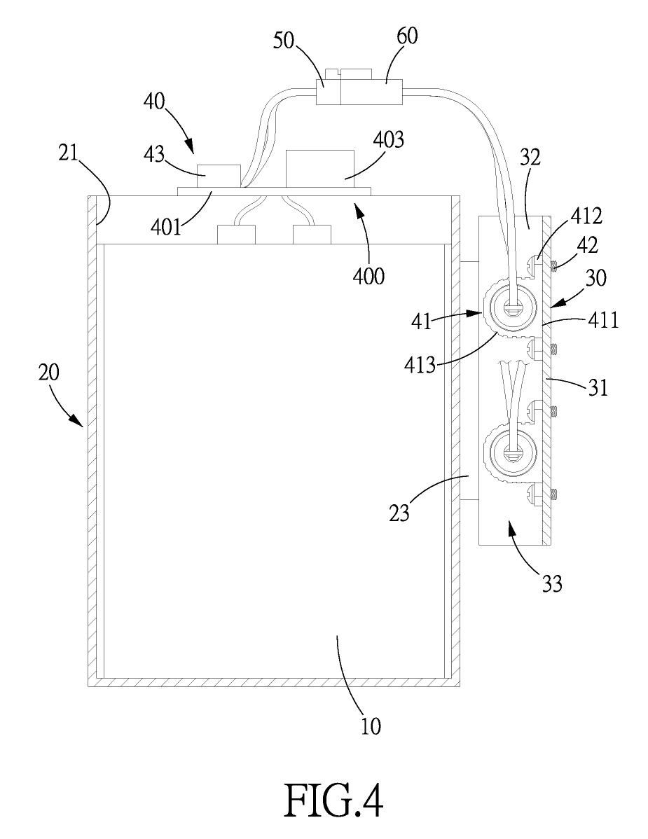

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

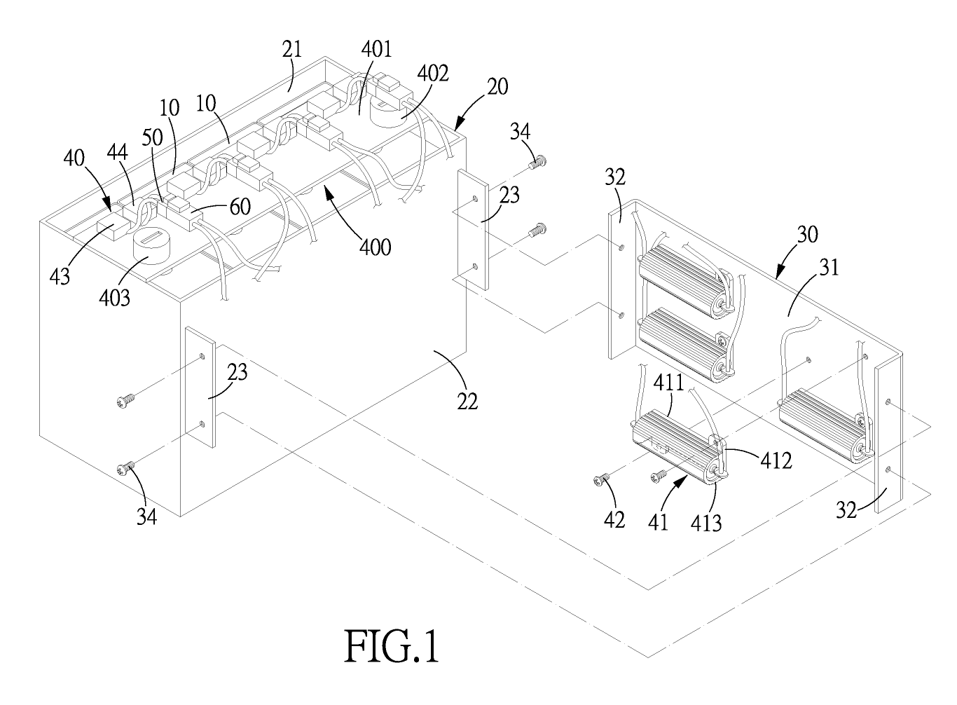

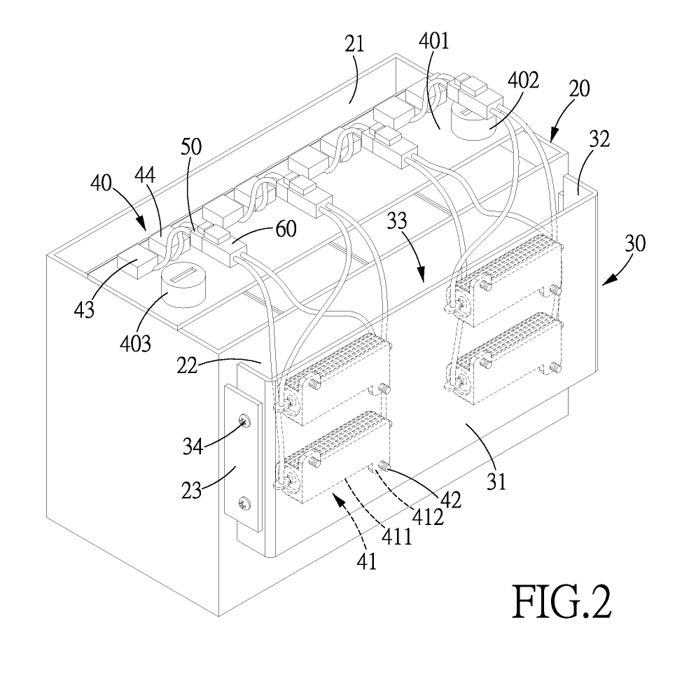

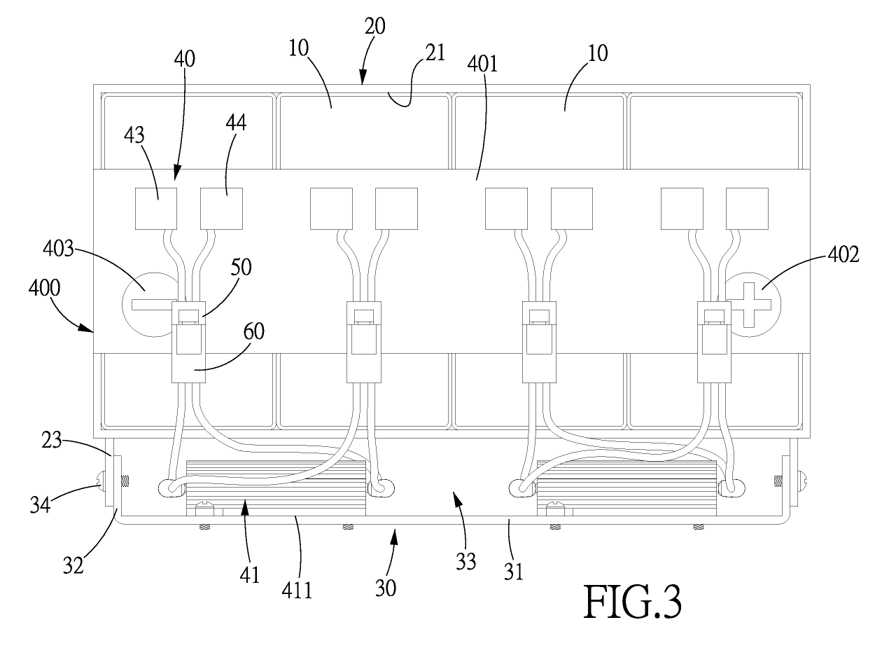

Referring to FIGS. 1-3, a secondary battery with an overcharge protection device in accordance with the present invention comprises: a battery case 20, a heat dissipation plate 30, an overcharge discharge device 400, a plurality of first connectors 50, and a plurality of second connectors 60.

The battery case 20 is made of metal with good heat dissipation performance and includes a chamber 21 for holding a plurality of secondary battery cells 10. In this embodiment, there are four secondary battery cells 10, and the battery case 20 further includes an outer surface 22, and two spaced apart first connecting portions 23 protruded from the outer surface 22.

The heat dissipation plate 30 is made of metal with good heat dissipation performance and fixed to the battery case. In this embodiment, the heat dissipation plate 30 includes a heat dissipation portion 31 spaced apart from the outer surface 22 of the battery case 20, and two second connecting portions 32 formed on the heat dissipation portion 31 and fixed to the first connecting portions 23, so that the heat dissipation plate 30 and the battery case 20 define a heat dissipation space 33 for passage of liquid. The first and second connecting portions 23, 32 are fixed together by screws 34.

The overcharge discharge device 400 is disposed in the battery case 20 and includes a plurality of overcharge discharge modules 40 electrically connected to the secondary battery cells 10. The number of the overcharge discharge modules 40 is equal to that of the secondary battery cells 10, and each of the overcharge discharge modules 40 includes a balance resistor which is fixed to the heat dissipation plate 30 and used to consume electric power. In this embodiment, each of the balance resistors is a cement resistor 41. The cement resistor 41 is fixed to the heat dissipation portion 31 of the heat dissipation plate 30, located in the heat dissipation space 33, and includes a heat conduction surface 411 abutted against the heat dissipation plate 30, two locking portions 12 fixed to the heat dissipation plate 30 by screws 42, and a plurality of heat dissipation grooves 413.

Each of the first connectors 50 is electrically connected to a corresponding one of the overcharge discharge modules 40.

Each of the second connectors 60 is electrically connected to a corresponding one of the cement resistors 41 and removably fixed to a corresponding one of the first connectors 50.

Since the battery case 20 and the heat dissipation plate 30 are made of metal with good heat dissipation performance, when each of the secondary battery cells 10 is overcharged, the heat energy produced by the secondary battery cells 10 will be absorbed by the battery case 20 and dissipated into surrounding air via the outer surface, so as to quickly reduce the temperature of the respective secondary battery cells 10 during the charging process. When each of the secondary battery cells 10 is overcharged during charging process, the cement resistors 41 of the overcharge discharge modules 40 will consume electric power. At this moment, the heat dissipation grooves 413 will dissipate the heat energy converted from electric power into surround air, and the heat conduction surface 411 will also bring the heat energy to the heat dissipation plate 30, so that the heat energy can be quickly dissipated into surrounding air by the heat dissipation plate 30, and the temperature of the cement resistors 41 is effectively lowered. With the metal made battery case 20, the heat dissipation plate 30 and the high-power cement resistors 41 mounted on the heat dissipation plate 30, the second battery of the present invention, without complicated structure, will provide a good heat dissipation performance and charging effect during charging process, substantially reducing the possibility of high temperature explosion.

It is to be noted that, with the metal made battery case 20, the heat dissipation plate 30 and the high-power cement resistors 41 mounted on the heat dissipation plate 30, the second battery of the present invention does not need extra heat dissipation system, therefore is simply structured and easy to manufacture.

In addition, the cement resistors 41 on the heat dissipation plate 30 are electrically connected to the first connectors 50 of the overcharge discharge modules 40 via the second connectors 60, and the first and second connectors 50, 60 are connected in a removable manner, which makes the maintenance and assembly of the secondary battery of the present invention much convenient.

It is to be noted that the overcharge discharge device 400 further comprises a circuit board 401 which is disposed at the entrance of the chamber 21 of the battery case 20 and provided for electrical connection of the overcharge discharge modules 40 and the secondary battery cells 10. Each of the overcharge discharge modules 40 comprises a semiconductor switch 43 as a discharge switch, and a voltage detecting unit 44 for detecting the voltage of the secondary battery cells 10. Since the voltage detecting unit 44 and the semiconductor switch 43 are of conventional technology, further explanations are omitted. The circuit board 401 further comprises a positive electrode 402 and a negative electrode 403 as power output terminals of the secondary battery.

While we have shown and described various embodiments in accordance with the present invention, it is clear to those skilled in the art that further embodiments may be made without departing from the scope of the present invention.

What is claimed is:

1. A secondary battery with an overcharge protection device comprising:
a battery case with a chamber for holding a plurality of secondary battery cells;
a heat dissipation plate fixed to the battery case;
an overcharge discharge device disposed in the battery case and including a plurality of overcharge discharge modules electrically connected to the secondary battery cells, the number of the overcharge discharge modules being equal to that of the secondary battery cells, and each of the overcharge discharge modules including a balance resistor which is fixed to the heat dissipation plate and used to consume electric power; characterized in that:
the battery case and the heat dissipation plate are made of metal, the balance resistors are cement resistors, a plurality of first connectors are electrically connected to the overcharge discharge modules, and a plurality of second connectors are electrically connected to the cement resistors and removably fixed to a corresponding one of the first connectors.

2. The secondary battery with the overcharge protection device as claimed in claim 1, wherein the battery case further includes an outer surface, and two spaced apart first connecting portions protruded from the outer surface, the heat dissipation plate includes a heat dissipation portion spaced apart from the outer surface of the battery case, and two second connecting portions formed on the heat dissipation portion and fixed to the first connecting portions, so that the heat dissipation plate and the battery case define a heat dissipation space for passage of liquid.

3. The secondary battery with the overcharge protection device as claimed in claim 1, wherein the overcharge discharge device further comprises a circuit board which is disposed at an entrance of the chamber of the battery case and provided for electrical connection of the overcharge discharge modules and the secondary battery cells.
